(19) United States
(12) Patent Application Publication
(10) Pub. No.: US 2007/0261260 A1
(43) Pub. Date: Nov. 15, 2007

(54) Pattern making tool

(76) Inventor: Anna Louise Ermina Djapo Loza, San Pedro, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/803,072

(22) Filed: May 11, 2007

Related U.S. Application Data
(60) Provisional application No. 60/747,131, filed on May 12, 2006.

(51) Int. Cl. B43L 7/00

(52) U.S. Cl. 33/566

(57) ABSTRACT

A sewing aid for marking a fabric with a marking device is disclosed. A non-opaque template includes a front surface, a back surface, and a peripheral edge having at least a top edge, a bottom edge, a left edge, and a right edge. A first notch of a first shape and a second notch of a second shape are formed in the top and bottom edges of the template, respectively. Each notch may further include indicia thereon, the indicia generally being parallel to the top and bottom edges of the template. In use, the fabric may be marked in the shapes by using the top or bottom edge of the template as a guide for the marking device. Corresponding notches may be marked against a garment template, and cut in the fabric for pieces of a garment. As such, the notches indicate proper alignment of the pieces for sewing. Each first indicia, second indicia, third indicia, and fourth indicia may be used as a guide to ensure the top or bottom edges of the template are parallel with the edge of the template.

### CROSS-REFERENCE TO RELATED APPLICATIONS

This application claims the benefit of U.S. Provisional Patent Application 60/747,131 filed on May 12, 2006.

### STATEMENT REGARDING FEDERALLY SPONSORED RESEARCH AND DEVELOPMENT

Not Applicable.

### FIELD OF THE INVENTION

This invention relates to garment construction, and more particularly to a tool for making fabric patterns.

### DISCUSSION OF RELATED ART

When sewing together a garment from pieces a fabric, the pieces are usually traced and cut-out from a garment pattern. Patterns are typically made from tissue paper, or a heavier card-stock paper referred to as “manila” paper. The patterns include indicia to convey information about the seam allowances and alignment marks to the garment manufacturer. Such alignment marks and seam allowance indicators must be transferred in some way to the corresponding cut-out pieces of fabric for constructing the garment from the pieces of the fabric.

One common method of making indications in fabric pieces that correspond to marks on the garment pattern is to cut a small slit in the edge of the fabric pattern at the appropriate location. Once the fabric pieces are joined together and sewn, the slits are not visible and do not affect the integrity of the finished garment. However, with certain types of fabric, such as knit fabrics, it is not advisable to cut such slits in the edges of the garment pieces since such fabrics will tend to unravel and tear at the point of such slits. Consequently, with knitted fabrics, marks must be made with ink or in some other manner than cutting the fabric.

There are prior art tools for making slits in non-knit fabrics. For example, U.S. Pat. No. 3,154,861 to Rubenstein teaches a device for making slits in non-knit fabric for marking locations on the fabric. However, such a tool is unusable with knit fabrics. There are no known tools on the market for aiding in the marking of knit fabrics. U.S. Pat. No. 4,565,006 to Vouyouka teaches a similar marking and cutting template for non knit fabrics.

U.S. Pat. No. 1,433,496 to Capuano, teaches a measuring device having a notch for marking and cutting fabric. The device disclosed in Capuano, however, makes no provision for distinctly marking front and rear sides of a garment with differently-shaped notches. Further, the device disclosed in Capuano is directed specifically to pants and is therefore, cumbersome to use with other types of garments.

Therefore, there is a need for an inexpensive, easy-to-use pattern making tool which will permit knit fabrics to be marked and notched, without unraveling the knit fabric, at the appropriate places corresponding to alignment marks and seam allowance indicators on a garment pattern. Such a needed device would be effective for various sizes of seam allowances, and would allow for differentiating notches for front and back fabric pieces. The present invention accomplishes these objectives.

### SUMMARY OF THE INVENTION

The present device is a pattern making tool for marking a fabric so that the user will know how to assemble the pieces of the garment. A substantially flat template comprises a front surface, a back surface, and a peripheral edge that joins the front and back surfaces. The template is preferably translucent or transparent so that when the template covers a portion of the fabric, the fabric is at least partially visible therethrough. The peripheral edge preferably includes at least a top edge, a bottom edge, a left edge, and a right edge.

A first notch of a first shape, such as a triangle, is formed in the top edge of the template. Similarly, a second notch of a second shape, such as a trapezoid or rectangle, is formed in the bottom edge of the template. The first and second notches are preferably coaxially aligned along a common longitudinal axis thereof, the longitudinal axis being preferably parallel to each left and ridge edges of the template. A third notch may be further formed through the template, the third shape being between and coaxially aligned with the first and second notches. Additional notches of varying shapes may be provided as needed.

In the preferred embodiment of the invention, the first notch further includes at least one first indicia, the indicia generally being parallel to the top edge of the template. Similarly, the second notch preferably includes at least a second indicia, the indicia generally being parallel to the bottom edge of the template. The indicia are used to enlarge or reduce the size of the triangular or trapezoidal shape notch as desired by the user.

In use, the pattern is marked with the various shapes by using the top or bottom edge of the template as a guide for making the marks. The pattern is then used to make corresponding notches in the fabric and the fabric is cut forming the different pieces of a garment. The notches indicate to the user the proper placement and alignment of the pieces so that the user knows how and where to sew the pieces together. Each first indicia, second indicia, third indicia, and fourth indicia may be used as a guide to ensure the top or bottom edges of the template are parallel with the edge of the pattern. As the template is non-opaque, markings on the pattern are easily visible therethrough, facilitating the proper placement of the template on the pattern and/or fabric.

The present invention is an inexpensive, easy-to-use tool which permits all types of fabrics, including knit fabrics, to be marked and notched at the appropriate places corresponding to alignment marks and seam allowance indicators on a garment pattern. The present device is effective for various sizes of seam allowances, and allows for differentiating notches for front and back fabric pieces. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is top plan view of the invention;

FIG. 2 is a right-side elevational view of the invention, the left-side elevational view being a mirror image thereof;

FIG. 3 is a top plan view of the invention as used on a garment;

FIG. 4 is a top plan view of two pieces of a garment shown properly aligned before sewing; and

FIG. 5 is a top plan view of two pieces of a garment shown properly aligned before sewing.

### DETAILED DESCRIPTION OF THE PREFERRED EMBODIMENT

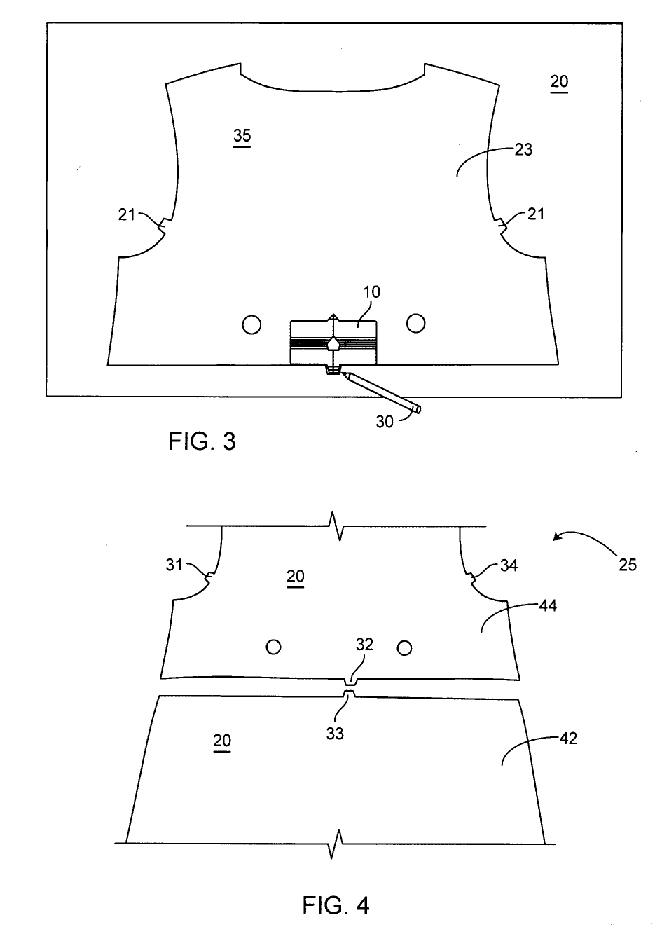

The present invention is a pattern making tool 10 for marking a fabric 20 with a marking device 30 (the marking device is shown in FIG. 3). A substantially flat template 40 comprises a front surface 50, a back surface 60, and a peripheral edge that joins the front and back surfaces 50 and 60. The template is preferably transparent (or translucent) so that when the template 40 covers a portion of the fabric 20, the fabric 20 will be at least partially visible therethrough. The template 40 may be cut or stamped from a sheet of plastic stock material, or may be injection molded from a substantially clear or translucent material.

The peripheral edge is comprised of a top edge 72, a bottom edge 74, a left edge 76, and a right edge 78, such that the template 40 is formed in a substantially rectangular shape, in the preferred embodiment, wherein the top and bottom edges 72 and 74 are parallel and orthogonal to the left and right edges 76 and 78. However, different shapes for the template 40 may be used as well without varying from the spirit and the scope of the present invention.

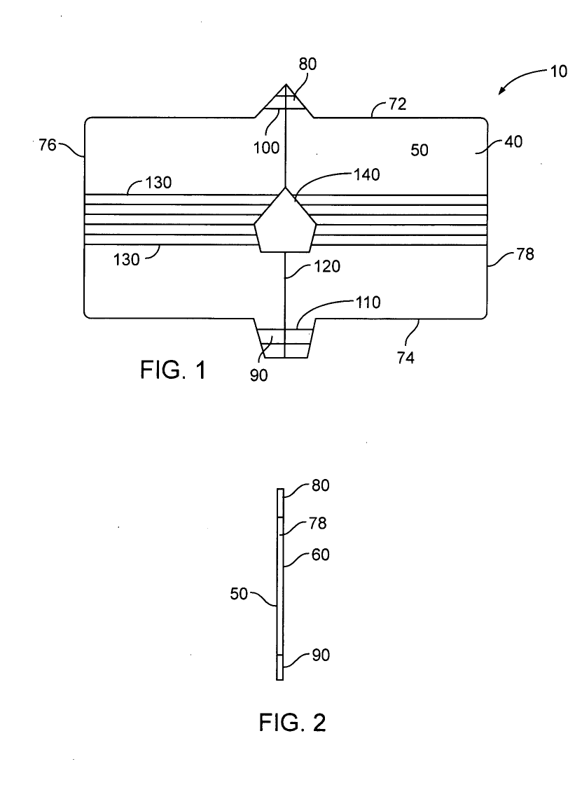

A first notch 80 having a first shape, such as a triangle, is formed in the top edge 72 of the template 40 (as shown in FIG. 1). Similarly, a second notch 90 having a second shape, such as a trapezoid or rectangle, is formed in the bottom edge 74 of the template 40. The first and second notches 80 and 90 are preferably coaxially aligned along a common longitudinal axis 120 thereof, the longitudinal axis 120 being preferably parallel to each left and ridge edges 76 and 78 of the template 40. A cut-out 140 is further formed as an opening in the template 40, shown in FIG. 1. The cut out is a combination of the first and second notches 80 and 90, such as a five-sided combination of the triangular first shape 85 and the trapezoidal second shape 95 (FIG. 1). The cut out 140 is between and coaxially aligned with the first and second notches 80 and 90. With the marking device, the user can trace portions of the cut-out 140 to create the precise shape desired onto the pattern. For example, if a triangular notch were desired, the user would place the template on the edge of pattern and trace the sides of a triangle following the diagonal lines of the cut-out 140. The pattern is then made by cutting on the traced triangular lines. The pattern is placed on the fabric and the various fabric pieces are cut following the pattern.

It is conventional in the garment industry that a trapezoid notch indicates the back pieces of the garment and a triangular notch indicates the front pieces. A notch on the armhole, as in FIG. 4, is an indication to the seamstress that a sleeve is to be attached to the armhole. The sleeve (not shown) would be marked with a triangular notch on one side of the sleeve and a trapezoidal notch on the opposite side of the sleeve. The fabric pieces thus have “built in” instructions to the seamstress via the notches. Each piece is sewn to another piece by matching the notches of each piece with the notch of the same shape on another fabric piece. The notches also indicate whether a piece is the back or front piece of the garment.

In the preferred embodiment of the invention, the first notch 80 further includes at least one first indicia 100 thereon, the indicia 100 generally being parallel to the top edge 72 of the template 40. Similarly, the second notch 90 preferably includes at least one second indicia 110 thereon, the indicia generally being parallel to the bottom edge 74 of the template 40. A third indicia 100 and 110 is preferably included on both the first and second notches 80 and 90, respectively along the common longitudinal axis 120 thereof. Finally, a fourth indicia 130 may be included between and substantially parallel to the top and bottom edges 72 and 74 of the template 40.

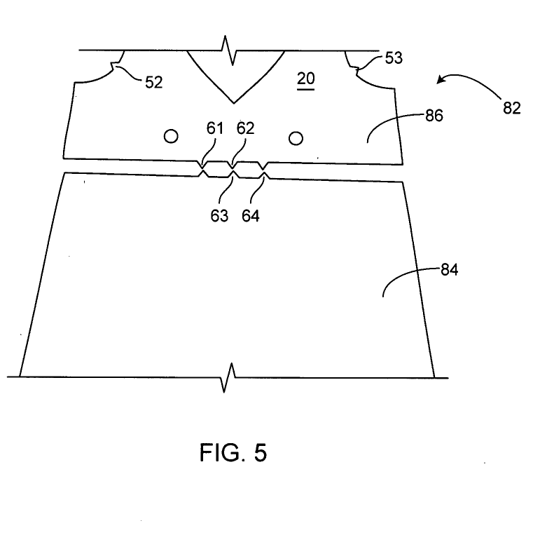

In use, the pattern is formed for the front piece of the garment, for example, and marked with the first shape 80 from the template, a triangle in the embodiment shown in FIG. 5, a triangular notch 52 is traced. The top edge 72 of the template 40 may be used as a guide for tracing with the marking device 30. The pattern for the back piece of the garment may be similarly marked with the trapezoidal notch. After the pattern is made, it is used to cut the various pieces of the garment. The notches are used to indicate, in the FIG. 5 embodiment that the top piece of the garment is joined to the bottom piece of the garment. The triangular notches 61 and 62 in the top piece of the garment are matched to triangular notches 63 and 64, shown in FIG. 5. The triangular notches indicate that the top back piece is to be joined to the bottom back piece. In this manner, the individual pieces of the garment may be quickly matched when being readied for sewing together the garment.

Each first indicia 100, second indicia 110, third indicia 120, and fourth indicia 130 may be used as a guide to ensure the top edge 72 or bottom edges 74 of the template 40 are parallel with the edge of the pattern 35. As the template 40 is transparent, markings 36 on the pattern 35 are easily visible therethrough, facilitating the proper placement of the template 40 on the pattern 35 and/or fabric 20. Seam allowances (not shown) are easily marked when the template 40 includes a plurality of each of the first indicia 100, second indicia 110, and fourth indicia 130, each spaced ⅛ of an inch apart, for example.

While a particular form of the invention has been illustrated and described, it will be apparent that various modifications can be made without departing from the spirit and scope of the invention. For example, the triangular first shape 85 and the trapezoidal second shape 95 may be readily replaced with any other contrasting shapes as is known in the art. Likewise, the overall shape of the template 40, while shown in the preferred embodiment as rectangular, may be any other suitable shape including a square, a circle, an oval, a triangle, a parallelogram, a trapezoid, or the like. Accordingly, it is not intended that the invention be limited, except as by the appended claims.

What is claimed is:

1. A pattern making tool for marking a fabric pieces with a marking device, comprising:
a substantially flat template comprising a front surface and a back surface, each surface connected by a peripheral edge, the peripheral edge including a top edge, a bottom edge, a left edge, and a right edge;
a first notch having a trapezoidal or rectangular shape formed on and protruding from said peripheral edge of said template; and
a second notch having a triangular shape formed in, and protruding from, said peripheral edge of said template;
the marking device tracing one or more shapes of said first notches onto the fabric and the marking device tracing one or more shapes of said second notch onto the fabric pieces such that first notches on said fabric pieces are matched with the other first notches and said second notches on said fabric are matched with other second notches for indicating how the fabric pieces are to be sewn together.

3. The pattern making tool of claim 1 wherein the first notch further includes at least one first indicia thereon, the indicia generally parallel to the top edge of the template.

4. The pattern making tool of claim 1 wherein the second notch further includes at least one second indicia thereon, the indicia generally parallel to the bottom edge of the template.

5. The pattern making tool of claim 1 wherein the first notch includes a third indicia along a longitudinal axis thereof.

6. The pattern making tool of claim 1 wherein the second notch includes the third indicia along a longitudinal axis thereof.

7. The pattern making tool of claim 1 wherein first notch and the second notch includes the third indicia along a common longitudinal axis thereof.

8. The pattern making tool of claim 1 wherein the template includes at least one forth indicia thereon, each forth indicia being between and substantially parallel to the top and bottom edges of the template.

8. The pattern making tool of claim 1 wherein a third notch is formed through the template, the third shape being between and coaxially aligned with the first and second notches.

9. The pattern making tool of claim 1 further including:
an opening in the said template having a shape which is combination of a triangle and a trapezoid for tracing a triangular or a trapezoidal notch on said pattern.

10. The method of constructing a garment comprised of fabric pieces using a template having protruding first and second shapes comprising the steps of:
placing the template onto the pattern and marking the fabric with an outline of at least one protruding first triangular shape;
placing the template onto the pattern and marking the fabric with an outline of at least one protruding second trapezoidal or rectangular shape;
cutting the pattern into individual pieces with at least one shape and at least one second shape;
placing the pattern onto the fabric;
cutting the fabric into pieces by tracing the pattern;
sewing the pieces of the fabric together utilizing the first and second shapes to indicate how each piece is attached to the other pieces of the fabric.

11. The method of claim 10 for constructing a garment comprised of fabric pieces having seam allowances using a template having protruding first and second shapes and indicia, the method further comprising the steps of:
utilizing the indicia to enlarge the first or second shapes or to mark a seam allowance.
